(19) United States
(12) Patent Application Publication
(10) Pub. No.: US 2024/0192700 A1
(43) Pub. Date: Jun. 13, 2024

(54) PERSON DETECTION METHOD AND SYSTEM FOR COLLISION AVOIDANCE

(71) Applicant: BlooLoc NV, Hasselt (BE)

(72) Inventors: Ivo VANDEWEERD, Hasselt (BE); Leander HENDRIKX, Hasselt (BE); Koen DEFORCHE, Hasselt (BE)

(21) Appl. No.: 18/531,862

(22) Filed: Dec. 7, 2023

(30) Foreign Application Priority Data
Dec. 9, 2022 (EP) 22212635.1

(51) Int. Cl. G05D 1/622; B66F 9/06; B66F 9/075; G05D 1/246; G05D 1/65; G05D 1/69; G06V 20/52; G06V 20/58; G06V 40/10; G05D 107/70; G05D 111/10

(52) U.S. Cl. CPC G05D 1/622; B66F 9/063; B66F 9/0755; G05D 1/246; G05D 1/65; G05D 1/69; G06V 20/52; G06V 20/58; G06V 40/10; G05D 2107/70; G05D 2111/10

(57) ABSTRACT

Methods and systems for collision avoidance, preferably in industrial settings. The systems and methods use a three-dimensional feature map fitted onto a two-dimensional floor plan; determining the absolute position of a first industrial vehicle on the floor plan; determining the absolute position of a second industrial vehicle on the floor plan; detecting a person on images a camera mounted on the second industrial vehicle; determining the relative position of said person on the floor plan relative to said second industrial vehicle; determining the absolute position of said person on the floor plan; determining an alarm contour for the first industrial vehicle on said floor plan; providing the absolute position of said person on the floor plan to the first industrial vehicle, wherein an alarm action is triggered for the first industrial vehicle if the absolute position of said person is detected inside the alarm contour of the first industrial vehicle

### FIELD OF THE INVENTION

The current invention relates to a method and system for collision avoidance, preferably in industrial settings, in circumstances comprising larger fleets of (industrial) vehicles.

### BACKGROUND

From DE 102 34 730 A1 a method for determining the position of a transport vehicle within an effective range is of known art, in which moveable first objects, transported by the transport vehicle, (transport units, pallet cages, beverage crates or similar) and stationary second objects (for example, walls, supporting pillars) are present. The effective range is stored in the form of a digital map, which contains the positions of the objects. The forklift truck has a laser radar (=LADAR), an electronic compass, and a kinematic GPS, connected with an on-board computer, which supply data to the on-board computer. For purposes of determining the position of the forklift truck the LADAR scans a contour of the environment and thereby registers the warehouse goods items located in the immediate environment, whereupon the result of this scan is compared with the digital map stored in a central computer; on the basis of this comparison the on-board computer or the central computer can determine a position of the forklift truck within the effective range. The LADAR also registers the separation distance between the forklift truck and the known objects, in order to generate an image of the forklift truck's environment. From the determined measurements, the position of the forklift truck is determined by a comparison with the data of the digital map using trigonometrical calculations and methods. For purposes of improving the determination of position, data for moveable third objects can also be held in the digital map; these are registered during the scan and are used to update the database. These third objects can be other transport vehicles and/or unknown obstacles.

Disadvantageously the objects called upon for purposes of registering position must have a measurable contour so as to enable a determination of position by way of the laser scanning procedure. Therefore, identical objects (e.g. supporting pillars, Euro-pallets, etc.) cannot be uniquely identified. Moreover, in accordance with DE 102 34 730 A1 it is necessary to determine differences between the scans made by the vehicle and the centrally managed map so as to determine from these the exact position. This means that an exact determination of absolute position is not possible, instead a probable position is determined by way of an exclusion method; while in the best-case scenario this does indeed correspond to the actual absolute position, it can also deviate significantly from the latter. The determination of position by means of laser radar scanning in accordance with known art encounters its limitations in particular if the environment is similar or the distances involved prevent or place limits on the scanning procedure (e.g., in the case of an empty warehouse with supporting pillars, with empty storage areas, or storage areas with stored goods items that have identical structures, or in the external environment).

From US2009/0198371A1 a system for goods items tracking is furthermore of known art, with a fixed base system and mobile systems that are linked with vehicles. The mobile system has an identification sensor for purposes of registering objects with coding. The monitored space is also fitted with position markers that are individually different; these are arranged in the ceiling region. The vehicle has an optical position sensor device with a camera that is upwards directed; this records images of the environment so as to register position markers present in the visual field and to establish their identities. The positions of the position markers in the recorded image are used to register the position and the angular orientation of the vehicle. When a position marker is registered the database in the memory of a mobile computer system on the vehicle is also updated. However, this system has the disadvantage that no determination of position is possible if there is no marker in the field of view of the camera, i.e., no other system is available to execute a determination of position. Accordingly, a marker must be in the field of view at all locations where a position is required. In storage depots, however, a registration of position is required at all locations and at all times, in order to track even goods items that are set down in unscheduled storage areas. This in turn means that the storage depot must be fitted with very many markers; this leads to an extremely high level of expenditure, particularly in the case of large storage depots. Moreover, by virtue of the attachment of markers to the ceiling, this system of known art is disadvantageously limited to an internal environment.

From DE 44 29 016 A1 a navigation system for driverless vehicles, in particular for transport systems in workshops, is of known art, in which high-contrast objects in the environment, in particular ceiling lights, are recorded by means of an imaging sensor that moves with the vehicle. From the location of these ceiling lights the position and angle of orientation of the vehicle are then determined. Through the use of the high-contrast ceiling lights for the registration of an absolute reference position the costs of the navigation system are to be kept low.

Known systems for detecting persons, as discussed in this document, have the disadvantage of resulting in a lot of false positives, which make its application in industrial settings impossible, as it would create huge amounts of downtime. The opposite, increasing the threshold for positive detections, results in a highly dangerous environment where questionable detections are ignored, again creating an unacceptable situation.

WO 2017/042677 A1 discloses a system for determining the position of an individual within a working area, in particular a working area where an industrial vehicle operates. The system comprises an industrial vehicle that is free to move in a plurality of directions within the working area and a plurality of video-cameras mounted on the same industrial vehicle. A GPS unit is then provided for determining the position of the industrial vehicle, and to generate corresponding position data p(ti). The data and the images are, then, processed by a processing unit, by applying at least a predetermined object recognition algorithm, in such a way to determine the position of an individual within the working area, and his/her spatial position.

Jingwei Song et al disclose in “Fusing Convolutional Neural Network and Geometric Constraint for Image-based Indoor Localization” an image-based localization framework that explicitly localizes the camera/robot by fusing CNNs and sequential images' geometric constraints.

EP 3 475 925 A1 discloses a method and system for tracking electronic badges by detecting, by a badge communicator on a select industrial vehicle of a fleet of industrial vehicles, the presence of an electronic badge and performing a badge logging transaction in response to detecting the electronic badge. The badge logging transaction includes receiving, by the badge communicator, a badge identifier transmitted by the detected electronic badge. The badge logging transaction also includes determining, by the badge communicator, an offset measurement of the electronic badge relative to the select industrial vehicle, electronically determining a vehicle location of the select industrial vehicle, and identifying a badge location based upon the determined vehicle location and the measured offset. The badge logging transaction can also include generating a time stamp, and wirelessly communicating a badge locator message to a remote server, the badge locator message including the badge identifier, the badge location, and the timestamp.

De Xu et al disclose in “Ceiling-based Visual Positioning for an Indoor Mobile Robot With Monocular Vision” that parallels and corner points on a ceiling in an office are used as features for visual positioning for an indoor mobile robot. Based on these natural features, a visual positioning method is proposed, using a camera mounted on top of the mobile robot and pointed to the ceiling.

Furthermore, what is crucial in these contexts is that the reaction speed needs to be as high as possible. The processing of images into a decision on actual detection, and thus a potentially dangerous situation based on the presence of persons detected in that image, and then the subsequent further processing of this detection into an alarm action (or not), must be executed without latency.

The invention thereto aims to provide an improved methodology and system for person detection for vehicles in busy surroundings, where full visibility is not guaranteed.

### SUMMARY OF THE INVENTION

The present invention and embodiments thereof serve to provide a solution to one or more of above-mentioned disadvantages. To this end, the present invention relates to a method for person detection for collision avoidance in a location, preferably in industrial surroundings such as warehouses, with multiple industrial vehicles, preferably mobile material handling units such as forklifts, automated guided vehicles (AGVs), etc. The methods for person detection for collision avoidance in a location with multiple industrial vehicles, said method comprises the following steps: (a) generating or updating a three-dimensional feature map of the location using an upwards-directed camera mounted on at least a first and a second of the industrial vehicles; (b) fitting said three-dimensional feature map onto a two-dimensional floor plan; (c) determining the absolute position of the first industrial vehicle on the floor plan using images from said upwards directed camera of said first industrial vehicle and the three-dimensional feature map; (d) determining the absolute position of the second industrial vehicle on the floor plan using images from said upwards directed camera of said second industrial vehicle and the three-dimensional feature map; (e) detecting a person on images from at least one laterally-directed camera mounted on the second industrial vehicle; (f) determining the relative position of said person on the floor plan relative to said second industrial vehicle based on said images; (g) determining the absolute position of said person on the floor plan by means of the relative position of said person to the second industrial vehicle and the absolute position of said second industrial vehicle on the floor plan; (h) determining an alarm contour for the first industrial vehicle on said floor plan; and, (i) providing the absolute position of said person on the floor plan to the first industrial vehicle, wherein an alarm action is triggered for the first industrial vehicle if the absolute position of said person is detected inside the alarm contour of the first industrial vehicle.

In a second aspect, the present invention relates to a system for collision avoidance in a location, preferably in industrial surroundings such as warehouses, with multiple industrial vehicles, preferably mobile material handling units such as forklifts, automated guided vehicles (AGVs), etc. The systems for person detection in collision avoidance for industrial vehicles in a location, wherein the system comprises a plurality of vehicle kits provided on each of the industrial vehicles, each kit comprising: (a) a first camera mounted on the industrial vehicle, directed upwards with respect to the vehicle; (b) at least one person detection camera mounted on the industrial vehicle, directed laterally with respect to the vehicle; (c) a processing unit configured for: (i) determining an absolute position of the industrial vehicle on a predefined floor plan using images from said first camera of said industrial vehicle and a predefined three-dimensional feature map of the location; (ii) detecting a person on images from the person detection camera and determining the relative position of said person relative to said industrial vehicle based on said images on the floor plan; (iii) determining the absolute position of said person on the floor plan by means of the relative position of said person to the industrial vehicle and the absolute position of said industrial vehicle on the floor plan; (iv) determining an alarm contour for the industrial vehicle on said floor plan; (d) a wireless communication unit, configured for broadcasting the determined absolute position, and for receiving broadcasted determined absolute positions from other communication units; wherein said processing unit is further configured for executing an alarm action if the absolute position of a person is detected inside the alarm contour of the industrial vehicle.

### DESCRIPTION OF FIGURES

FIG. 1 shows a top view/floor plan for a situation in prior art collision avoidance systems.

FIG. 2 shows a top view/floor plan for a situation in prior art collision avoidance systems.

FIG. 3 shows a top view/floor plan for a situation in prior art collision avoidance systems.

FIG. 4 shows a top view for a situation in an embodiment according to the present invention.

FIG. 5 shows a top view for a situation in a variation embodiment according to the present invention.

FIG. 6 shows a top view for a situation in an embodiment according to the present invention.

FIG. 7 shows a floor plan for a situation in an embodiment according to the present invention, including a vehicle.

FIG. 8 shows a floor plan for a situation in an embodiment according to the present invention, including persons on the floor plan.

FIG. 9 shows an alarm contour drawn up for an industrial vehicle according to an embodiment of the invention.

FIG. 10 shows a floor plan for a situation in an embodiment according to the present invention, including industrial vehicles, people, and alarm contours for the vehicles.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g., component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

The term “absolute position” provides for a position that is absolute in a given coordinate system. This can be reduced to the floor plan of the location itself.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures, or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect, the invention provides a method for person detection for collision avoidance in a location, preferably in industrial surroundings, more preferably warehouses, with multiple industrial vehicles, preferably a mobile material handling unit, said method comprising the following steps:
generating or updating a three-dimensional feature map of the location using an upwards-directed camera mounted on at least a first and a second, preferably all, of the industrial vehicles;
fitting said three-dimensional feature map onto a two-dimensional floor plan;
determining the absolute position of the first industrial vehicle on the floor plan using images from said upwards directed camera of said first industrial vehicle and the three-dimensional feature map;
determining the absolute position of the second industrial vehicle on the floor plan using images from said upwards directed camera of said second industrial vehicle and the three-dimensional feature map;
detecting a person on images from at least one laterally-directed camera mounted on the second industrial vehicle;
determining the relative position of said person on the floor plan relative to said second industrial vehicle based on said images;
determining the absolute position of said person on the floor plan by means of the relative position of said person to the second industrial vehicle and the absolute position of said second industrial vehicle on the floor plan; and
determining an alarm contour for the first industrial vehicle on said floor plan;
providing the absolute position of said person on the floor plan to the first industrial vehicle;

An alarm action is triggered for the first industrial vehicle if the absolute position of said person is detected inside the alarm contour of the first industrial vehicle.

The above methodology is specifically applicable to a fleet of industrial vehicles, which can be autonomous or operated by a driver (in loco or remotely). In locations, such as industrial warehouses, many such vehicles are present and on the move, while a number of ‘pedestrians’ are also present. In order to promote safety, safe zones are often designated, for instance footpaths, where pedestrians can walk safely, and where the vehicles are not allowed to drive, are automatically slowed, and/or take other measures for safety. However, on many occasions, the pedestrians will still need to exit such safe zones for performing certain tasks and/or accessing certain zones. In order to safeguard the integrity of the pedestrians, further measures need to be taken, especially in industrial surroundings where the vehicles require high amounts of concentration to be operated (and often also are suboptimal in terms of providing a clear view for the driver), reducing the focus of the driver on their surroundings and such pedestrians. Finally, industrial surroundings typically also have a great amount of blind spots and obstacles for the visibility, such as racking, boxes, stacks of material, etc., resulting in a danger of a person appearing from around a corner when a driver does not expect them.

By providing most, and preferably all, of the industrial vehicles that are operational in a location with an upwards-directed camera and at least one laterally-directed camera (preferably more than one, to ensure a 360° vision), safety for all persons on in the location can be ensured, by the separate vehicles creating a moving mesh of person detection and localization nodes, that alerts (nearby) nodes when detecting a person with the location of said person. Using the upwards-directed camera for position determination of the industrial vehicles, by comparing the images of the upwards-directed camera to a previously generated three-dimensional map (or at least, to images generated therefrom). This previously generated map is not necessarily complete or definitive, as in principle, only a top section is relevant (for instance, only the ceiling can be realistically represented in said map), and can even be expanded/updated based on images from the cameras of the industrial vehicles, but serves as a point of comparison for the present images. When the image from the upwards-directed camera shows a sufficiently high degree of similarity (to be determined) to an image from the three-dimensional map, the position on the floor plan for said image of the three-dimensional map is set as the position of the industrial vehicle.

Alternative positioning systems exist, but are very susceptible to interference, especially in industrial surroundings. Typical odometry provides for results that diverge strongly over time, while typical correcting factors, such as signaling beacons, etc., are difficult to implement due to interference on the signals that renders the result unreliable. Visual odometry also has limited success, since the environment itself changes frequently (racking is changed, material in racks is moved, changed, etc.).

However, the applicant makes clever use of the fact that in such settings, there is always a high ceiling in which a number of points of recognition are provided. This is firstly in the shape of lighting on the ceiling, but can be appended by including skybridges, beams, windows, skylights, and other recognizable features. By defining a three-dimensional feature map with such points of recognition, the images from the previously generated three-dimensional map can be easily compared based with recognized features on the image from the upwards-directed camera.

By using such easily processable images (easily identifiable features, typically limited number of features but also few non-feature objects), the processing can be performed on the vehicle itself, which is a preferred embodiment, with a relatively simple processing unit (compact, low power requirements).

The use of one or more laterally-facing cameras (with a view on the surroundings around eye-level, thus having a view on the floor as well as the space a person would occupy in the surroundings of the vehicle) to monitor the environment of the vehicle, means that the driver no longer needs to invest too much of their attention on this. Again, by using a processing unit that is preferably on the vehicle, presence of a person on the images can be identified easily and quickly, and the relative position of the person to the vehicle can be determined. Combining the relative position of the person with the known absolute position of the vehicle from the images of the upwards-directed camera, the absolute position of the person can be determined on the floor plan.

The relative position is typically determined by detecting the person in the image, usually via a bounding box on the image, and is achieved specifically by detecting the bottom boundary of the person (bounding box) corresponding to their feet. This bottom boundary can be mapped relatively to the camera, and to the vehicle, by knowledge of the camera position and orientation with respect to the vehicle, and the camera settings. By using that relative position, the projection of said person onto the floor plan can be determined, and therewith their absolute position on the floor plan.

This absolute position is provided, preferably directly, to other (nearby) industrial vehicles, which also know their own absolute position on the floor plan. The absolute position of the person(s) can be provided directly, for instance by broadcasting the absolute position of the person(s) to any vehicle close enough to receive the broadcast.

Broadcasting simplifies the communication of the absolute position of detected persons as it is simple, omnidirectional and low-range, and guarantees that the information is received by nearby vehicles, since detection of a person is of no relevance to faraway vehicles, which reduces computational activities for the vehicles overall. By using a low-latency wireless channel to broadcast the information, the check whether or not a person is in the alarm contour can be performed quickly, making sure a follow-up (alarm) reaction is executed in time.

The term “laterally-directed camera” comprises tilted cameras as well, and is used to refer to cameras that have a field of view that effectively cover the zone wherein a person would be present, i.e., on ground level. It can be advantageous to place the cameras with a (small) downward tilt, since it is often positioned at an elevation on the vehicle, which itself is often already high. Furthermore, this allows for a more accurate position detection, by having more of the ground (and other elements on the ground) in the field of view as a perspective for the person that is detected.

Each vehicles determines an individual alarm contour on the floor plan with respect to its own absolute position. This alarm contour defines the zone in which presence of a person is relevant for the vehicle, in terms of safety for the person and/or vehicle. This contour can be influenced by a number of factors, such as current speed, max speed, orientation, load, but can also be influenced by environmental factors such as obstacles and objects around it. For instance, where the alarm contour for a vehicle may for instance be set at 10 meter around it in every direction as a standard, this might mean that, when it is driving near racks, that the alarm contour also covers zones at the other side of the rack, while a person in such a zone on the other side is actually of no relevance for the vehicle. As such, the alarm contour can be adapted taking such factors into account, by cutting off zones when they are not reachable by the vehicle in a short amount of time. Of course, this depends on the floor plan being annotated with certain obstacles and relevant info about the obstacles (traversable, non-traversable).

A check is performed for a vehicle whether any of the received absolute positions for detected persons is inside of the alarm contour for the vehicle. If so, an alarm action is triggered. This alarm action can differ based on the relative position of the person to the vehicle. For instance, the alarm contour may be subdivided in an inner contour and an outer contour (and possible one or more intermediary contours), and/or may have zones, for which the alarm can be set independently. Gradations of the alarm actions can comprise full visual and/or auditory alarm signals, automated slowdown, automated stop, etc.

The advantage of the present system is that it allows monitoring in a reliable manner, with minimal additional hardware necessary on the vehicles, or outside of them, as the processing is preferably performed on the vehicles. In none of the prior art systems, the vehicles share their person detection information in such a highly informative, fast and reliable manner, critically increasing safety.

In alternative embodiments, the absolute position of the person(s) can also be sent indirectly to one or more other vehicles, by providing the info to an intermediary system (central server for instance), which in turn provides the info to one or more other vehicles (can be via broadcasting or direct transmittal to vehicles).

In further variations, the intermediary system can be provided with the absolute positions of the industrial vehicles as well as the absolute positions of the person(s), and can perform the steps off-vehicle, and then provide instructions directly to the vehicles separately (for instance, issue an alarm or trigger the alarm for vehicle 2 based on detection of a person by vehicle 1 at a location in the alarm contour of vehicle 2), instead of having the vehicles run the check of whether a person is in their alarm contour.

Preferably, processing of the images (both for person detection and position determination of vehicle and persons) is performed on the vehicles themselves. However, it should be noted that the processing of the images can be performed off-vehicle, although the on-vehicle processing is strongly preferred, as it does not require the images to be sent from the vehicle and allows faster reaction to alarm situations.

Preferably, multiple laterally-directed cameras are provided, in order to maximize the field of view. Most preferably, a full 360° view is desired, and three or more cameras are used to ensure this. In most cases, at least one forward-facing camera is used.

In a preferred embodiment, the step of determining the absolute position of the first and/or second industrial vehicle is carried out by means of particle filter localization technique (also known as Monte Carlo localization technique). Departing from an original position and orientation, the algorithm statistically predicts a distribution of positions (and orientations) at a later time based on further input (for instance information on speed, elapsed time, or sensor input such as from images, etc.), the so-called particles, which each represents a possible state (position, orientation) for the vehicle. For said particles, a corresponding feature image is generated from the three-dimensional feature map, and compared to the images from the actual upwards-directed camera. Based on the level of correspondence, the weights of the particles are adjusted (and particles are periodically resampled according to their weights) and used as the new distribution of positions (and orientation) for the vehicle, for the next iteration of the algorithm.

In industrial settings, much of the surroundings are temporary, and can be rearranged frequently. As mentioned, certain features at ‘lower levels’ are moved often, and are not reliable features for comparison with images at a later time, as these features, such as racks, stacks of materials, boxes, etc., may no longer be positioned at the same place. It is in this light that the applicant focuses on structural (quasi-permanent) components, that are rarely changed or moved (if at all), such as lighting configurations and structural characteristics at higher altitudes (skylights, beams, skybridges, windows, etc.). A further advantage of using imagery of higher zones of the location, is that they are more easily processed. The images have much less ‘clutter’ and are barer than images at ground level, where material, racking, people, machinery, etc., can be present, resulting in a more complex image that is harder to process for features. Additionally, the mentioned features are by themselves easy to identify.

Preferably, this three-dimensional feature map is generated with a high-accuracy mapping system, which does not necessarily need to be the same as the ones positioned on the vehicles. This can for instance be drawn up by a specific vehicle provided with specific imaging sensor(s) and positioning sensor(s) that allow more accurate figures, thus providing more reliable features, and high-accuracy positioning, guaranteeing that the drawn-up map is very reliable. The map can be updated and/or regenerated regularly, either via such a specifically designed mapping vehicle, but may also be updated based on the images from the industrial vehicles themselves while operational.

In a further preferred embodiment, the absolute position of the industrial vehicle is determined by comparison of an expected feature image for each particle in the particle filter localization technique based on the three-dimensional feature map with the image from the upwards directed camera. As mentioned, by generating an expected feature image for the particles, this can be compared in a very simple fashion to the “real” image from the camera. Focusing on the presence and relative position of the features allows fast and reliable comparison and provides a metric for determining which particle is most likely the actual position and orientation of the vehicle.

In an even preferred embodiment, the image from the upwards directed camera is processed into a feature image, wherein a probability density function is calculated for the particles in the particle filter localization technique, and wherein a most likely location is determined from the probability density function and set as the absolute position of the industrial vehicle. This absolute position is then sent to other vehicles, in order to check whether a person is present in their alarm contour.

In a preferred embodiment, the method comprises a step of calibrating the laterally-directed camera, which step includes mapping at least one, preferably at least 10% or even all, pixel on the images of said laterally-directed camera to a distance and direction relative to said industrial vehicle. The calibration step allows the method to very accurately determine the relative position of the person with respect to the vehicle, and thus a highly accurate absolute position which can be provided to the other vehicles nearby.

In a preferred embodiment, the laterally-directed camera is pre-calibrated. This pre-calibration comprises a very accurate determination of the characteristics for the camera (both operational, such as lens system, focus depth, etc., as well as the very exact position and inclination). This specifically means determining (or estimating) the camera matrix (with the intrinsic camera parameters) and distortion coefficients, and the extrinsic parameters (camera pose: location and orientation).

Based on these parameters, the position of an object or pixel on an image can be determined on a relative two-dimensional map with respect to the vehicle. As mentioned, this is usually achieved by detection of the person, generating a bounding box in the image for the person, of which the bottom (i.e., the feet of the person), is processed into a relative position with respect to the vehicle, which is then used to provide an absolute position projected onto the floor plan.

Preferably, every pixel in the image is processed to correspond to a specific location with respect to the vehicle, which is only achievable by careful calibration of the position and inclination of the laterally-directed camera on the vehicle. By focusing on the feet, the position of the person can be carefully mapped on the floor plan.

In a further preferred embodiment, the distance and direction to which a pixel is mapped are defined on a plane coincident with the floor supporting the material handling unit. In some embodiments, the angle pitch of travel direction of the unit is used in order to obtain the correct location projection on the floor plan.

In a further preferred embodiment, the position of a person relative to the industrial vehicle is determined by detecting a pixel coincident with a foot of said person, and determining the distance and direction to which said pixel is mapped.

In a preferred embodiment, the step of generating or updating the three-dimensional feature map is carried out using a simultaneous location and mapping (SLAM) approach.

In a preferred embodiment, the alarm contour of the industrial vehicle is calculated based on at least one of the following factors: speed of the industrial vehicle, driver reaction time, acceleration of the industrial vehicle, walking speed of detected person, mass and/or volume of the industrial vehicle, and direction of travel of the industrial vehicle. Further characteristics can be added to the above list, such as specific information on the industrial vehicle (for instance, time until stopping, max speed of the vehicle, turning radius of the vehicle, . . . ).

Most preferably, at least the present speed of the vehicle is taken into account as well as the direction of travel.

The alarm contour can be adapted further, depending on other factors. As mentioned, the presence of obstacles can be taken into account when generating the alarm contour, making sure that zones which are in practice unreachable due to such obstacles (for instance, wall, racking, etc.) are removed from the alarm contour so no unnecessary alarm actions are undertaken for persons detected there. Such adaptations can for instance make use of a maximal physical path that can be traversed by the vehicle within a certain time, making the alarm contour de facto a zone in which the vehicle can be expected to be within the certain time that can be set (for instance, next 10 seconds). Unreachable points are not present in the alarm contour that way, making it a realistic ‘danger zone’. This can be easily implemented by making use of an annotated, and preferably regularly updated, floor plan, depicting all permanent, semi-permanent and temporary obstacles and barriers.

These obstacles and barriers may also include theoretical obstacles, such as zones in which the vehicles are not allowed to drive. Specifically, designated pedestrian zones are removed from the alarm contours in most cases, to avoid alarm actions occurring in normal situations. Thus, the floor clan may comprise at least one designated pedestrian zones, whereby the alarm action is not triggered if the absolute position of said person is detected inside the alarm contour of the first industrial vehicle and said absolute position is in one of the at least one designated pedestrian zones. These pedestrian zones are usually walkways.

As mentioned, the detection of a person in the alarm contour of a vehicle triggers an alarm action for the vehicle. These actions can comprise one or more measures, and can even be triggered dependent on the exact situation (proximity of person, speed of vehicle, direction of vehicle, etc.).

A preferred action is the automated slowing down of the vehicle. This can be to a slower pace in general, or the vehicle can be forced into ‘crawl mode’, where the vehicle can still move (as this is required by most national regulations), but is reduced to an absolute minimum, for instance 5 km/h, 2.5 km/h or even 1 or 0.5 of 0.25 km/h.

Other actions can be the triggering of visual indicators (flashing lights, lights, warnings on screens, etc.), auditory indicators (alarm signals), vibrational indicators (vibrations on seat, steering wheel, smartphone, etc.) and/or other indicators. These can even convey a directionality of the possible danger, for instance flashing light on side of the detected person.

In some embodiments, the person that is detected can also be provided with a warning, for instance via a dedicated mobile electronic device they are wearing (smartphone, or specific unit). This can be sent via optical recognition of the user on the images, but also via detection of the presence of the user via said mobile electronic device. In such an embodiment, the industrial vehicle detecting a person in their alarm contour can broadcast a short-range signal to trigger these electronic devices in warning.

In some occasions, depending on the proximity (for instance, if the alarm contour comprises one or more inner contours inside of the alarm contour, usually with a similar shape but smaller size), different actions can be taken, typically more drastic as the proximity is higher, for instance outer contour results into visual/auditory alarms, while presence in an intermediary contour results into a medium slowdown, and presence in the innermost contour results into full shutdown or extreme slowdown.

In a preferred embodiment, further information on person detection can be received from stationary cameras, positioned in or near the location. The fixed position thereof results in a reliable location for the detected person, which is again provided to one or more of the industrial vehicles, for instance via broadcasting the absolute position of the person. This can be particularly advantageous to solve specific blind spots or known hazardous zones, where vehicles provide rarely provide information.

In a preferred embodiment, the three-dimensional feature map is specifically built around features comprising (ceiling) lights, and is preferably augmented by also comprising skylights. Even more preferably, other quasi-permanent features are introduced, such as racking, gates and/or windows.

In a specifically preferred embodiment, racking is used as features for the three-dimensional map, and use is made of subsections of the racking, which allow for improved recognition potential. More specifically, use is made of perpendicular intersections that are present in the racking due to girders or shelves and posts (beams and uprights) of the racking. These provide for easy-to-detect features in an image due to their 2D or even 3D nature, while remaining very recognize. This way, they provide for a very systematical and mathematical organized subset of features, given that these intersections are built/constructed under well-known dimensions and/or with recurrent interstices. As such, they provide for excellent orientation points that enable pinpoint localization of the absolute position of the industrial vehicle.

In particular, windows and/or other reflective surfaces are identified in the feature map, which knowledge is useful in filtering out “false” features recognized in the images from the upwards-directed camera, that are in fact duplicated features reflected in the windows/reflective surfaces. Knowledge of the position of windows and reflective surfaces, can be used to effectively remove these features, or compensate for them.

It is noted that presence of such reflective surfaces and windows is not necessary, as the incorrect detections can be filtered out via other means. For instance, this can be achieved by windows being recognized as such in the images (via a bounding box), and wherein the system is configured to disregard lights that are detected within the window.

In a preferred embodiment, the industrial vehicles communicate with each other and/or with a central server or central processing system via wireless communication, preferably via Bluetooth, Bluetooth Low Energy (BLE), LoRa, Wi-Fi, Zigbee, Z-wave, etc.

In a second aspect, the invention relates to a system for person detection in collision avoidance for industrial vehicles in a location, preferably industrial surroundings, more preferably warehouses, wherein the system comprises a plurality of vehicle kits provided on each of the industrial vehicles, each kit comprising:
a. A first camera mounted on the industrial vehicle, directed upwards with respect to the vehicle;
b. At least one person detection camera mounted on the industrial vehicle, directed laterally with respect to the vehicle;
c. A processing unit configured for:
   a. determining an absolute position of the industrial vehicle on a predefined floor plan using images from said first camera of said industrial vehicle and a predefined three-dimensional feature map of the location;
   b. detecting a person on images from the person detection camera and determining the relative position of said person relative to said industrial vehicle based on said images on the floor plan;
   c. determining the absolute position of said person on the floor plan by means of the relative position of said person to the industrial vehicle and the absolute position of said industrial vehicle on the floor plan;
   d. determining an alarm contour for the industrial vehicle on said floor plan;
d. A wireless communication unit, configured for broadcasting the determined absolute position, and for receiving broadcasted determined absolute positions from other communication units.

The processing unit is further configured for executing an alarm action if the absolute position of a person is detected inside the alarm contour of the industrial vehicle.

The advantages discussed above for the first aspect of the invention apply here as well. With a limited additional hardware setup, the individual vehicles can operate as a person detection mesh, informing their ‘neighbors’ of any people on the floor, and taking the necessary steps if such people are detected in their alarm contour.

In a preferred embodiment, the system is configured for executing any of the methods of the first aspect.

For instance, the system may comprise one or more stationary camera kits, said stationary camera kits comprising a stationary camera, a wireless communication unit and a processing unit for detecting a person on images from said stationary camera and determining the absolute position of said detected person on the floor plan. The wireless communication unit is configured for broadcasting said absolute location, and the processing unit of the vehicle kits takes into account the absolute location received from the stationary camera kits for executing the alarm action.

Most preferably, at least two, three or more laterally directed cameras are provided on the vehicles, in order to ensure a full 360° field of view around the vehicles.

The invention is further described by the following non-limiting examples which further illustrate the invention, and are not intended to, nor should they be interpreted to, limit the scope of the invention.

### Examples and Description of Figures

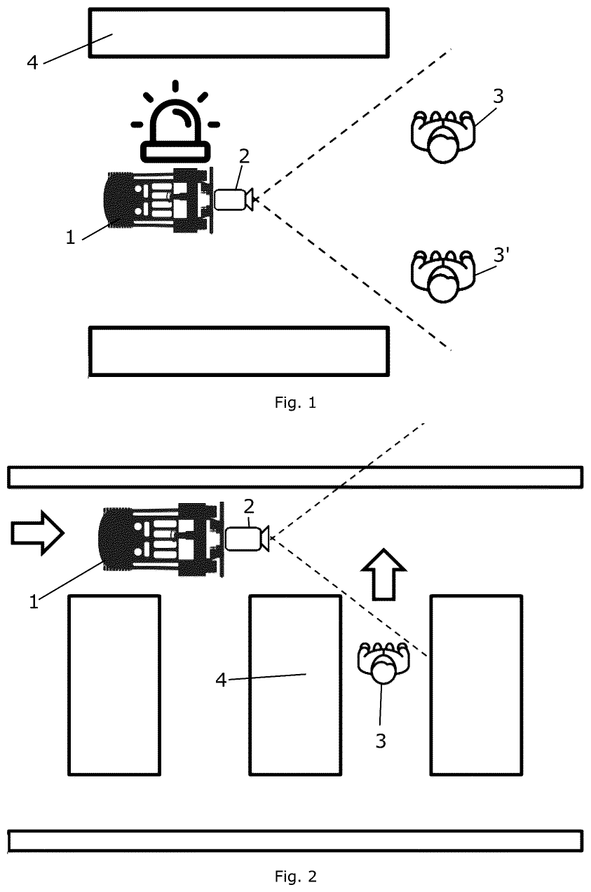

FIG. 1 shows one of the classical types of person detection on factory floors. Each industrial vehicle (1) is provided with a camera (2), and an alarm is triggered when they detect a person (3) in their field of view. Some more complex systems determine a relative position for the person (close enough or not) which is taken into account for deciding whether or not to trigger the alarm. However, as mentioned, this does not allow for highly cluttered structures, typical for industrial warehouses, where the field of view for each vehicle is often limited, and they have no knowledge on people around a corner, behind a rack or a pallet, etc. Such a situation is shown in FIG. 2, where the person (3) coming from behind the corner of a rack (4) only enters the field of view of the industrial vehicle (1) at the last second, resulting in a dangerous situation.

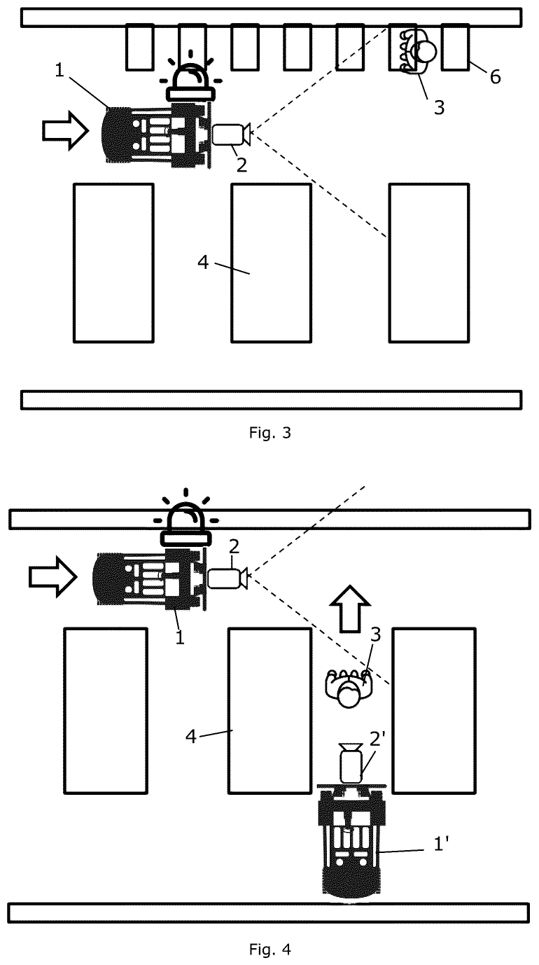

A further disadvantage of the known systems is shown in FIG. 3, where a pedestrian zone (foot path) is present on which persons can walk ‘safely’. However, the person detection system in most of the prior art fails to recognize such provisions, as they function purely on image processing of the camera. In order to accommodate for such safe zones, the foot path would need to be marked in such a manner that it is identifiable on the images. However, given the fact that the identification can be hindered by light (low or high), dirt, obstacles, etc., all of which are factors that can be expected in industrial settings, the state of the art is not equipped to deal with this properly and reliably.

The present system is shown in FIG. 4, where a first and a second industrial vehicle (1, 1′) are present, and shown on a floor plan on which racking (4) and other obstacles are shown. People (3) are also present. However, as in FIG. 2, the person (3) is not visible to the first industrial vehicle (1), but they are for the second industrial vehicle (1′). The laterally-directed camera of the second industrial vehicle (1′) detects the presence of a person in their field of view, and processes the images with the person to determine a relative position for said person to the second industrial vehicle. The second industrial vehicle has knowledge of its own absolute position with respect to the location, and combines this with the relative position for the person, to determine an absolute position for said person, which is then broadcast. The first industrial vehicle (1) receives the information from the second industrial vehicle, and checks whether the person's absolute position is inside of the alarm contour for itself. If so, the necessary alarm actions are triggered.

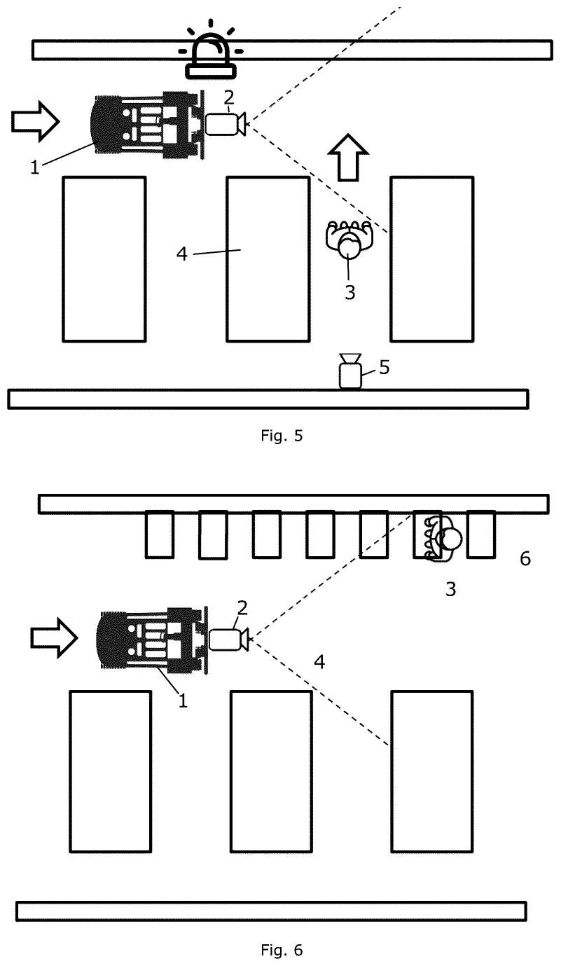

FIG. 5 shows an alternate version where a stationary camera (5) is present, which in this case serves the role of the second industrial vehicle (1′) of FIG. 4, and alerts the first industrial vehicle (1) of the location of the person (3).

FIG. 6 shows a similar situation as FIG. 3, where a person (3) is in a pedestrian zone (6). In this case, the industrial vehicle detects the person by itself (but the methodology applies to persons detected by other vehicles as well, per the above broadcasting of the position). The industrial vehicle determines the relative position of the person, and combines it with (in this case its own) the absolute position of the vehicle, to determine the absolute position of the person. The pedestrian zone (6) is marked as such on the floor plan, and if the absolute position of the person (3) is detected as being in such a pedestrian zone, no alarm actions are undertaken.

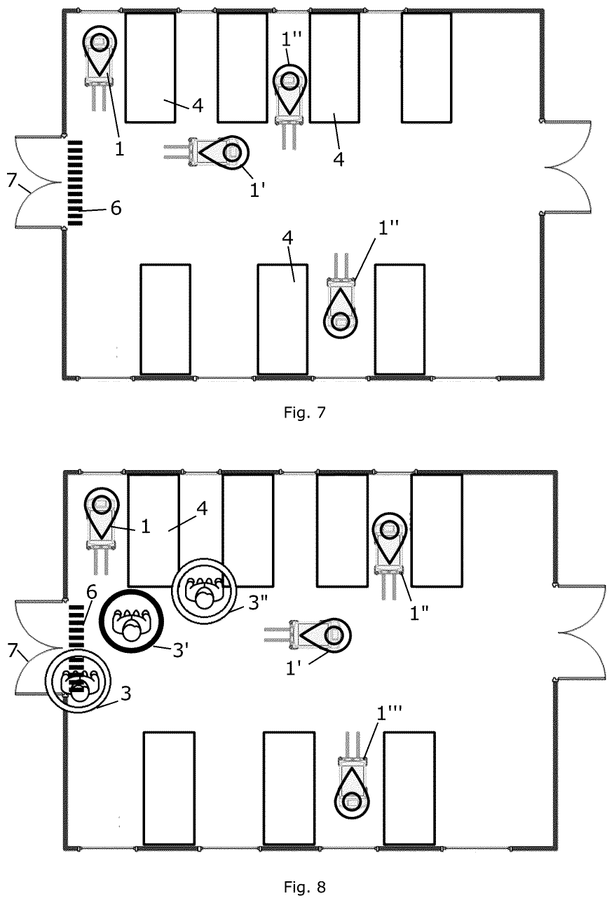

FIG. 7 shows a possible representation of the floor plan, wherein structural elements such as racking (4), doors (7), pedestrian zones (6), etc. are marked. The industrial vehicles (1, 1′, 1″, 1″′) determine their positions on said floor plan.

FIG. 8 shows an embodiment of the floor plan, where three persons (3, 3′, 3″) are detected by the cameras of the industrial vehicles (1, 1′, 1″, 1″′), and possible stationary cameras. The top left industrial vehicle (1) can see some of the people (3, 3′) but not the last person (3″) who is hidden by the racking (4). By making use of the annotated floor plan, the industrial vehicle can see the person (1) on the pedestrian zone (6), who does not trigger an alarm, and knows to trigger the alarm for the second person. The third person (3″) could theoretically fall in their alarm contour (absent in this figure), but the presence of the racking ensures that no alarm is triggered as said third person (3″) behind the racking is not considered in danger/a danger for the industrial vehicle (1).

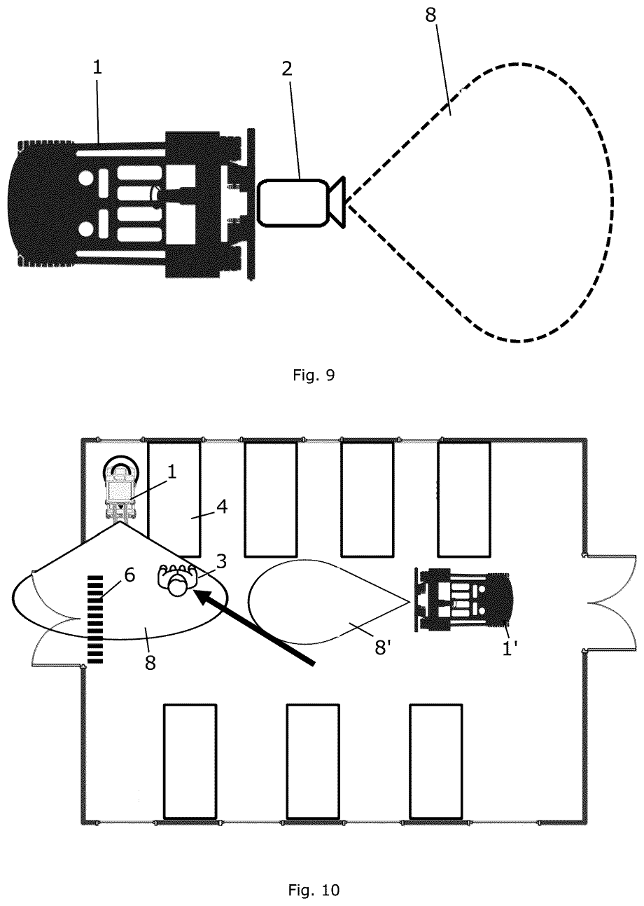

FIG. 9 shows a possible embodiment of an alarm contour (8) for a vehicle (1). Typically this is a forward-facing, balloon shaped contour, although in many cases, the contour can extend (to a lesser extend) to the sides and back of the vehicle.

As can be seen in FIG. 10, in which alarm contours (8, 8′) are shown on the floor plan for two vehicles (1, 1′), these contours differ depending on the vehicle. This can be the result of the speed of the vehicle at the time, the type of vehicle, etc.

In FIG. 10, the person (1) would not be visible to the leftmost industrial vehicle (1), due to the racking (4) hiding them. However, the rightmost industrial vehicle (1′) does have the person (3) in their field of view, and broadcasts its position to the other industrial vehicle (1), which triggers the alarm action for said industrial vehicle (1) since the position of the person on the floor plan is inside of the alarm contour (8) of the vehicle (1).

It is supposed that the present invention is not restricted to any form of realization described previously and that some modifications can be added to the presented example of fabrication without reappraisal of the appended claims. For example, the present invention has been described referring to vehicles in industrial settings, but it is clear that the invention can be applied to other situations as well.

The invention claimed is:

1. Method for person detection for collision avoidance in a location with multiple industrial vehicles, said method comprising the following steps:
a. generating or updating a three-dimensional feature map of the location using an upwards-directed camera mounted on at least a first and a second of the industrial vehicles;
b. fitting said three-dimensional feature map onto a two-dimensional floor plan;
c. determining the absolute position of the first industrial vehicle on the floor plan using images from said upwards directed camera of said first industrial vehicle and the three-dimensional feature map;
d. determining the absolute position of the second industrial vehicle on the floor plan using images from said upwards directed camera of said second industrial vehicle and the three-dimensional feature map;
e. detecting a person on images from at least one laterally-directed camera mounted on the second industrial vehicle;
f. determining the relative position of said person on the floor plan relative to said second industrial vehicle based on said images;
g. determining the absolute position of said person on the floor plan by means of the relative position of said person to the second industrial vehicle and the absolute position of said second industrial vehicle on the floor plan;
h. determining an alarm contour for the first industrial vehicle on said floor plan; and,
i. providing the absolute position of said person on the floor plan to the first industrial vehicle,
wherein an alarm action is triggered for the first industrial vehicle if the absolute position of said person is detected inside the alarm contour of the first industrial vehicle.

2. The method according to claim 1, wherein the step of determining the absolute position of the first and/or second industrial vehicle is carried out by means of particle filter localization technique.

3. The method according to claim 2, wherein the absolute position of the industrial vehicle is determined by comparison of an expected feature image for each particle in the particle filter localization technique based on the three-dimensional feature map with the image from the upwards directed camera.

4. The method according to claim 3, wherein the image from the upwards directed camera is processed into a feature image, wherein a probability density function is calculated for the particles in the particle filter localization technique, and wherein a most likely location is determined from the probability density function and set as the absolute position of the industrial vehicle.

5. The method according to claim 1, further comprising a step of calibrating the laterally-directed camera, which step includes mapping at least one pixel on the images of said laterally-directed camera to a distance and direction relative to said industrial vehicle.

6. The method according to claim 1, wherein the step of generating or updating a three-dimensional feature map of the location is carried out using a simultaneous location and mapping (SLAM) approach.

7. The method according to claim 1, wherein the alarm contour of the industrial vehicle is calculated based on at least one of the speed, acceleration, mass, volume and direction of travel of the industrial vehicle.

8. The method according to claim 1, wherein the alarm action comprises reducing speed to a maximum of 5 km/h.

9. The method according to claim 1, wherein the floor plan comprises at least one designated pedestrian zones, and wherein the alarm action is not triggered if the absolute position of said person is detected inside the alarm contour of the first industrial vehicle and said absolute position is in one of the at least one designated pedestrian zones.

10. The method according to claim 1, wherein the method further comprises a step of: each industrial vehicle broadcasting the absolute position of any person it detects.

11. The method according to claim 1, wherein one or more fixed camera kits are positioned in the location, configured for detecting a person on images from said stationary camera kit and determining the absolute position of said detected person on the floor plan, wherein the stationary camera kit is configured for broadcasting said absolute location, and wherein the step of triggering the alarm action takes into account the absolute position received from the fixed camera kits.

12. The method according claim 1, wherein the three-dimensional feature map comprises ceiling lights as features, and optionally skylights, racking, gates, and/or windows.

13. The method according to claim 12, wherein the features comprise windows and optionally other reflective surfaces, and wherein the step of determining the absolute position of the industrial vehicle accounts for reflections of features in said windows and optionally said other reflective surfaces.

14. The method according to claim 1, wherein the three-dimensional feature map comprises racking as features.

15. The method according to claim 14, wherein the three-dimensional feature map comprises racking intersections as features, wherein racking intersections are intersections of girders, beams or shelves of the racking and posts or uprights of the racking.

16. The method according to claim 1, wherein the three-dimensional feature map of the location is generated and updated using an upwards-directed camera mounted on all of the industrial vehicles.

17. The method according to claim 1, wherein the location is one or more warehouses.

18. The method according to claim 1, wherein the industrial vehicle is a mobile material handling unit.

19. System for person detection in collision avoidance for industrial vehicles in a location, wherein the system comprises a plurality of vehicle kits provided on each of the industrial vehicles, each kit comprising:
a. a first camera mounted on the industrial vehicle, directed upwards with respect to the vehicle;
b. at least one person detection camera mounted on the industrial vehicle, directed laterally with respect to the vehicle;
c. a processing unit configured for:
i. determining an absolute position of the industrial vehicle on a predefined floor plan using images from said first camera of said industrial vehicle and a predefined three-dimensional feature map of the location;
ii. detecting a person on images from the person detection camera and determining the relative position of said person relative to said industrial vehicle based on said images on the floor plan;
iii. determining the absolute position of said person on the floor plan by means of the relative position of said person to the industrial vehicle and the absolute position of said industrial vehicle on the floor plan;
iv. determining an alarm contour for the industrial vehicle on said floor plan;
d. a wireless communication unit, configured for broadcasting the determined absolute position, and for receiving broadcasted determined absolute positions from other communication units;
wherein said processing unit is further configured for executing an alarm action if the absolute position of a person is detected inside the alarm contour of the industrial vehicle.

20. System according to claim 19, wherein the system comprises one or more stationary camera kits, said stationary camera kits comprising a stationary camera, a wireless communication unit and a processing unit for detecting a person on images from said stationary camera and determining the absolute position of said detected person on the floor plan, wherein the wireless communication unit is configured for broadcasting said absolute location, and wherein the processing unit of the vehicle kits takes into account the absolute location received from the stationary camera kits for executing the alarm action.
